(19) United States
(12) Patent Application Publication
(10) Pub. No.: US 2010/0116864 A1
(43) Pub. Date: May 13, 2010

(54) MOTORIZED FASTENER APPLICATOR

(75) Inventor: Frederick W. Lamb, McDonald, PA (US)

Correspondence Address: BUTLER, SNOW, O'MARA, STEVENS & CANNADA PLLC, 6075 POPLAR AVENUE, SUITE 500, MEMPHIS, TN, 38119, US

(73) Assignee: PNEUTOOLS, INCORPORATED, Memphis, TN (US)

(21) Appl. No.: 12/612,062

(22) Filed: Nov. 4, 2009

Related U.S. Application Data
(60) Provisional application No. 61/112,574, filed on Nov. 7, 2008.

(51) Int. Cl. B27F 7/02

(52) U.S. Cl. 227/48

(57) ABSTRACT

A fastener applicator is disclosed which uses a rotating ramped cam to drive a staple or other fastener into a workpiece. The ramped cam rotates in a direction substantially parallel to the direction in which the fastener is driven into the workpiece. Optionally, the fastener applicator may also include a portion for holding caps and positioning a cap beneath each fastener before it is driven into the workpiece. A unique use of a sliding linkage allows for the coupling of the cap-positioning portion with the unique new fastener applicator or also with any standard existing fastener applicator.

### BACKGROUND OF THE INVENTION

Field of the Invention: The present invention relates, in general, to powered portable staplers and fastener applicators and, in particular, to powered portable staplers and fastener applicators for inserting fasteners, with or without caps, into flooring, roofing paper, insulation wrap, and coverings to houses, lumber, and other articles in the hobby or construction industry.

Background of the Art Including Identified Deficiencies: Staple guns and fastener applicators are well-known in the prior art for driving staples and nails into workpieces. These staple guns and fastener applicators of the prior art typically have a magazine which houses a supply of staples or fasteners as well as a part known as a “pusher.” This pusher, which is most often a compression spring, forces the supply of staples toward a driver blade, which then drives a succession of staples or nails, one at a time, into a workpiece. Staple guns and nail guns of the prior art typically are powered by either compressed air or by an electrical motor.

In the air-powered staple guns and nail guns of the prior art, compressed air is delivered either by a hose tethering the tool to a bulky air compressor or by cartridges containing compressed air. In these tools, the release of pressurized air forces the driver blade to reciprocate as it drives the staples or nails into the workpiece. Because of their pressurized air supply, these prior art tethered staple guns provide a relatively great driving force for the driver blade, but they have a disadvantage in that they are often bulky and heavy, and the tethering to the pressurized air supply reduces their applicability. Also, in the case of roofing applications, the air hose can cause a tripping-hazard, creating a hazardous condition for workers on the roof.

Electrically-powered staple and nail guns are well-known in the prior art. In these tools, an electric motor causes the driver blade to reciprocate. The corded staple guns and nail guns have the same problems encountered in air-powered staplers in that the cord reduces operating range and creates a tripping hazard. Some prior art staple guns, such as the Model CT-50 cordless staple gun manufactured by ARROW FASTENER COMPANY, Inc., 271 Mayhill Street, Saddle Brook, N.J. 07663, are cordless and, thus, are untethered, but the designs of prior art cordless and corded electrically-powered staple guns are still bulky and difficult to use in many applications. The Model CT-50 cordless staple gun has a motor with a horizontal shaft that reciprocates the staple driver blade up and down and a sensing circuit to stop the motor by sensing its rotational position, and thus the driver blade position, after a driving stroke has completed. The horizontal nature of the shaft increases the bulk of the gun.

It is therefore desirable to have a compact, portable, cordless electrically-powered stapling gun that can rapidly drive staples or fasteners into a workpiece.

It is further desirable to have a compact, portable, cordless electrically-powered capping and stapling gun that can rapidly drive staples through caps into a workpiece.

None of the references, either singly or in combination, disclose or suggest the present invention.

### BRIEF SUMMARY OF THE INVENTION

The present invention is a powered stapler or fastener applicator for driving a staple or other fastener into a workpiece in a first direction. The primary parts of the fastener applicator are a ramped cam, a motor, a bearing and a staple or other fastener driver. The cam rotates along an axis of rotation parallel, or substantially parallel, within a few degrees of the first direction in which the staple or other fastener is to be driven into the workpiece. The cam is ramped such that the bearing can ride up along the cam as it rotates and then drop off a cliff-like edge to drive in the staple or other fastener. Essentially, the cam has a ramped cam surface encircling the cam's axis of rotation. The ramped cam surface has a first height with respect to the axis of rotation, a second height with respect to the axis of rotation, and heights intermediate the first and second heights angularly about the axis of rotation from the first height to the second height. The ramped cam surface further has an abrupt cliff portion transitioning from the second height to the first height. The motor causes the cam to rotate about the axis of rotation. The bearing rides along in engagement with the ramped cam surface. The rise of the bearing as it rides up the ramped cam surface to the cliff and fall of the bearing as it drops at the cliff creates a reciprocal motion along the first direction as the cam rotates about the axis of rotation. The fastener driver is operably coupled to the bearing for joint movement therewith. As the bearing rides up the ramp, it pulls up the fastener driver. When the bearing drops off the cliff portion of the cam, it drives the staple or other fastener into the workpiece.

In an alternative embodiment of the invention, the stapler or fastener applicator drives the staple or other fastener into the workpiece through a cap. Caps are well known in the art and are typically thin but sturdy pieces of material, each having a large surface area through which a nail or fastener is driven. The cap prevents thinner materials from detaching from the workpiece by tearing around the nail or fastener. It is often used in applications, such as roofing, where a cap is used to hold down roofing paper or underlayment before a roof is shingled. In this alternative embodiment of the invention, the stapler or fastener applicator has all of the features listed above but also has a cap tower, a cap positioner, and a sliding linkage. The cap tower holds a plurality of stacked caps. The cap positioner positions a cap beneath the staple or other fastener such that the fastener driver drives the staple or other fastener through the cap and into the workpiece. The sliding linkage operably couples to the cap positioner and the fastener driver. The sliding linkage operates to cause the cap positioner to position the cap beneath the staple or other fastener before the fastener driver drives the staple or other fastener into the workpiece.

In a preferred embodiment of the invention, the fastener applicator is as described above but also has a spring or other piece of elastic material acting as a retractor operably coupled to the cap positioner and serving to retract the cap positioner as the fastener driver drives the fastener into the workpiece.

In an alternative embodiment of the invention, any fastener applicator, including any of the prior art fastener applicators, may be used with the unique and new cap positioning portion of the fastener and cap applicator. Such an embodiment includes a fastener applicator, which may be the fastener applicator as described above or any fastener applicator or staple which has a fastener driver which drives the staple or other fastener into a workpiece, a cap tower, a cap positioner, and a sliding linkage. The cap tower holds a plurality of stacked caps. The cap positioner positions a cap beneath the staple or other fastener such that the fastener driver drives the staple or other fastener through the cap, securing it to the workpiece. The sliding linkage operably couples to the cap positioner and the fastener driver and operates to cause the cap positioner to position the cap beneath the staple or other fastener before the fastener driver drives the staple or other fastener into the workpiece.

In a preferred embodiment of the invention as described in the preceding paragraph, the invention further comprises a retractor, such as a spring or other elastic material, operably coupled to said cap positioner and serving to retract said cap positioner as said fastener driver drives said fastener into said workpiece.

### BRIEF DESCRIPTION OF THE SEVERAL VIEWS OF THE DRAWINGS

These and other features, aspects, and advantages of the present invention will become better understood with regard to the following description, appended claims, and accompanying drawings where:

FIG. 1 is a side view of the internal mechanism of the fastener applicator 1 with the bearing 9 in a lowered position and the pushing spring 12 directly over the fastener driver 10.

FIG. 2 is a side view of the internal mechanism of the fastener applicator 1 with the bearing 9 in a raised position and the pushing spring 12 directly over the fastener driver 10.

FIG. 3 is a side view of the internal mechanism of the fastener applicator 1 with the bearing 9 in a lowered position and the pushing spring 12 surrounding the motor 8.

FIG. 4 is a side view of the internal mechanism of the fastener applicator 1 with the bearing 9 in a raised position and the pushing spring 12 surrounding the motor 8.

FIG. 5 is a side view of the fastener applicator 1 with an optional cap applicator portion 20 with the bearing 9 in a lowered position and the pushing spring 12 directly over the fastener driver 10.

FIG. 6 is a side view of the fastener applicator 1 with an optional cap applicator portion 20 with the bearing 9 in a raised position and the pushing spring 12 directly over the fastener driver 10.

### DETAILED DESCRIPTION

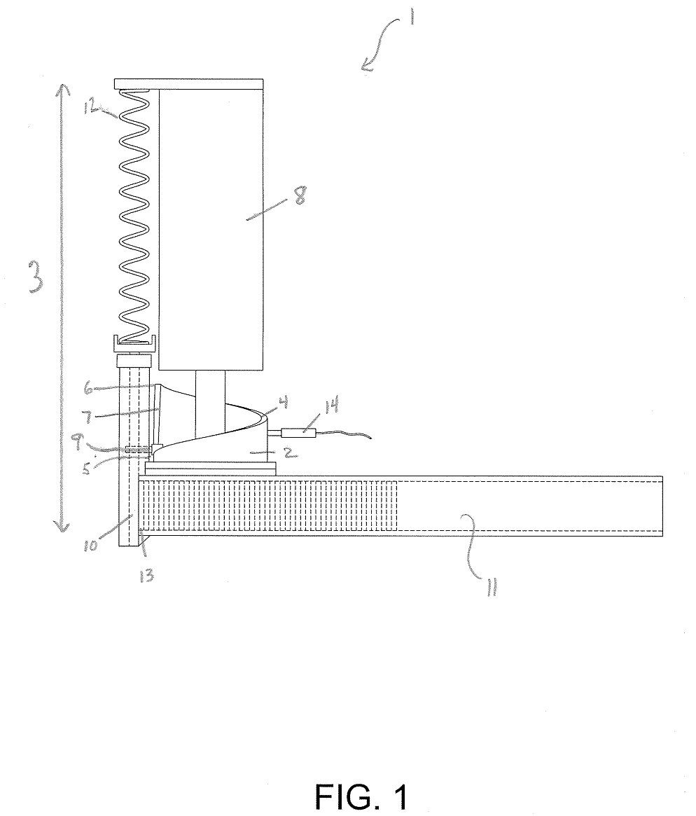

Referring to FIGS. 1-6 a new fastener applicator 1 is shown. The fastener applicator 1 drives a fastener 13 into a workpiece (not shown) in a first direction 3. To do this, a cam 2 is rotated by a motor 8. The cam 2 has a ramped cam surface 4. The ramped cam surface 4 has a lowest point, first height 5, and a highest point, second height 6. A bearing 9 rides up and down in first direction 3 along the ramped cam surface 4 as the cam 2 is rotated by motor 8. The bearing 9 is constructed such that there is minimal friction between the bearing and the ramped cam surface 4. This may either be accomplished by constructing the surface of the bearing 9 with a low-friction material or through use of mechanical means that allows the bearing 9 to roll along the ramped cam surface 4. A pushing spring 12 pushes down on the bearing 9 either directly or by pushing on a fastener driver 10, thus keeping the bearing 9 in contact with the ramped cam surface 4. A magazine 11 holds fasteners 13 to be applied, which may be staples or any other fasteners which may need to be applied to a workpiece.

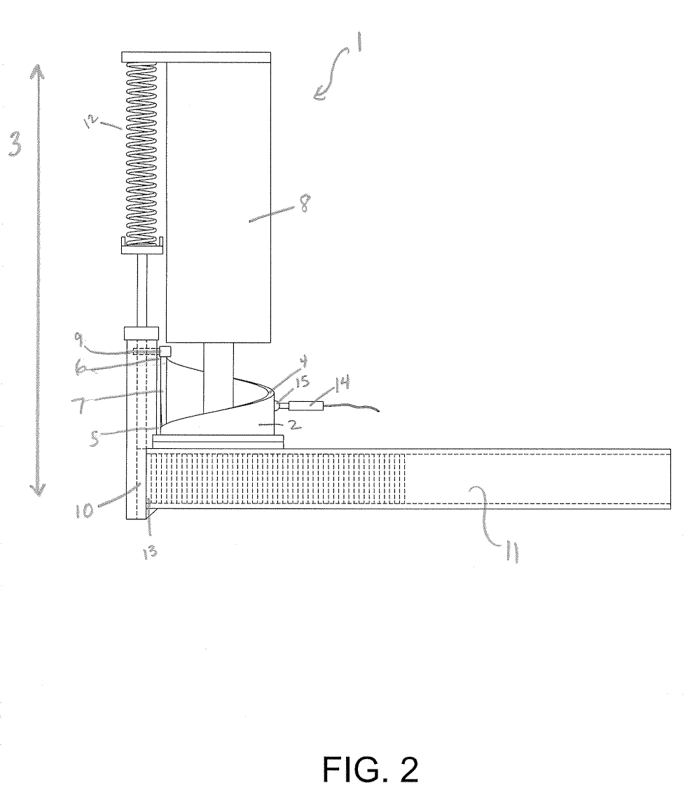

During operation, the motor 8 rotates the cam 2 causing the bearing 9 to move up in the first direction 3. The fastener driver 10 is operably coupled to the bearing 9. As the cam 2 rotates, the bearing 9 is drawn away from the workpiece, not shown, in the first direction 3, thus causing the fastener driver 10 to also be pulled away from the workpiece in the first direction 3. Simultaneously, the pushing spring 12 is compressed as the distance of the bearing 9 or fastener driver 10 from the workpiece increases. As shown in FIG. 2, when the fastener driver 10 is pulled clear of the entrance to the magazine 11, a fastener 13 is advanced under the fastener driver 10 and is ready to be driven into the workpiece. When the bearing 9 reaches the second height 6, it reaches an abrupt cliff portion 7 of the ramped cam surface 4. At that point, the height of the ramped cam surface 4 abruptly changes from the second height 6 to the first height 5. Without the support of the ramped cam surface 4, the fastener driver 10 and the bearing 9 are forced toward the workpiece by the pushing spring 12. The force of the pushing spring 12 causes the fastener driver 10 to impact the fastener in its immediate path and drive it into the workpiece. A microswitch 14 cuts the power to the motor 8 when it is triggered by a button 15 on cam 2. Power is restored when the operator reactivates the fastener applicator 1. In the embodiment shown in the figures, the microswitch 14 stops the motor right as the bearing 9 is near the second height 6 and ready to drive the fastener, not shown, into the workpiece, not shown. It would be clear to someone having ordinary skill in the art that the microswitch 14 could be placed at various points on the cam and the invention would still operate as intended. Although a mechanical switch is described herein, any number of mechanisms known in the art may be used to remove power from the motor after each fastener is driven into the workpiece, including, but not limited to electronic circuitry and magnetic switches.

It would be clear to one having ordinary skill in the art that the motor 8 could be battery powered, or otherwise powered with a battery or cord being located to provide power to the motor 8. It would also be clear to one having ordinary skill in the art to place a trigger on a handle for the disclosed fastener applicator 1, such that a user could trigger the motor to activate. Such technology is present, for example, in current corded and cordless drills.

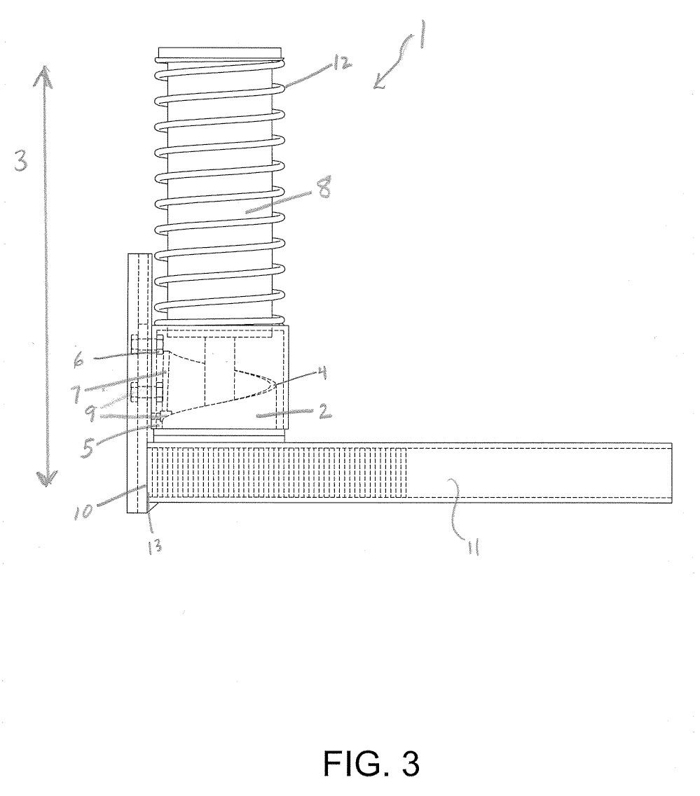

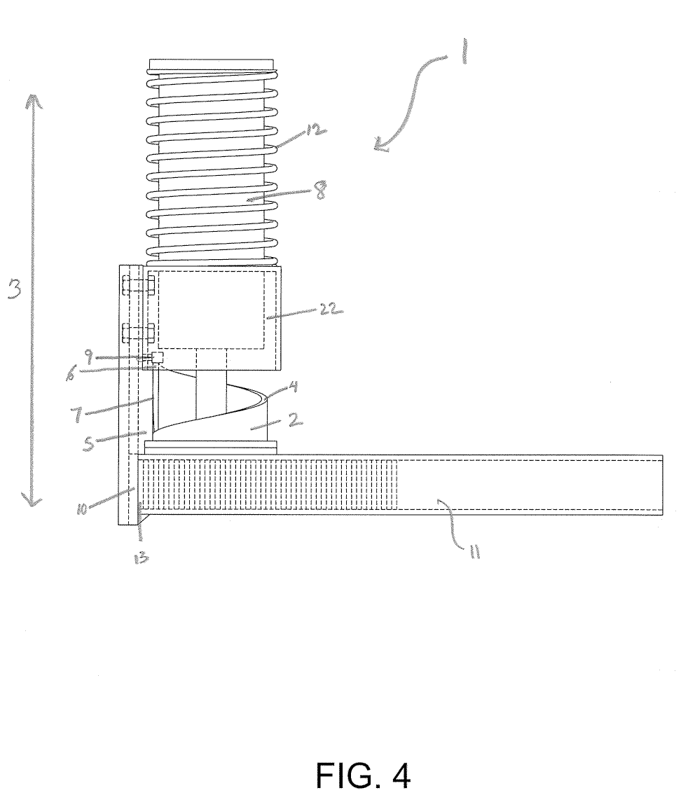

FIGS. 3 and 4 show an alternative embodiment of the invention. In the alternative embodiment, the operating mechanism of the fastener applicator 1 is substantially similar. One of the differences of the embodiment shown in FIGS. 3 and 4 is that the spring 12 is located around the motor 8. The other main difference is that a housing 22 encompasses the cam 2. The bearing 9 is disposed inside the housing 22, and the fastener applicator 10 is operably coupled to the bearing 9 by means of attachment to the housing 22. For purposes of this patent application, the term “operably coupled” means that the two parts are attached in such a way that they may operate as intended, although the two parts need not be directly attached to one another.

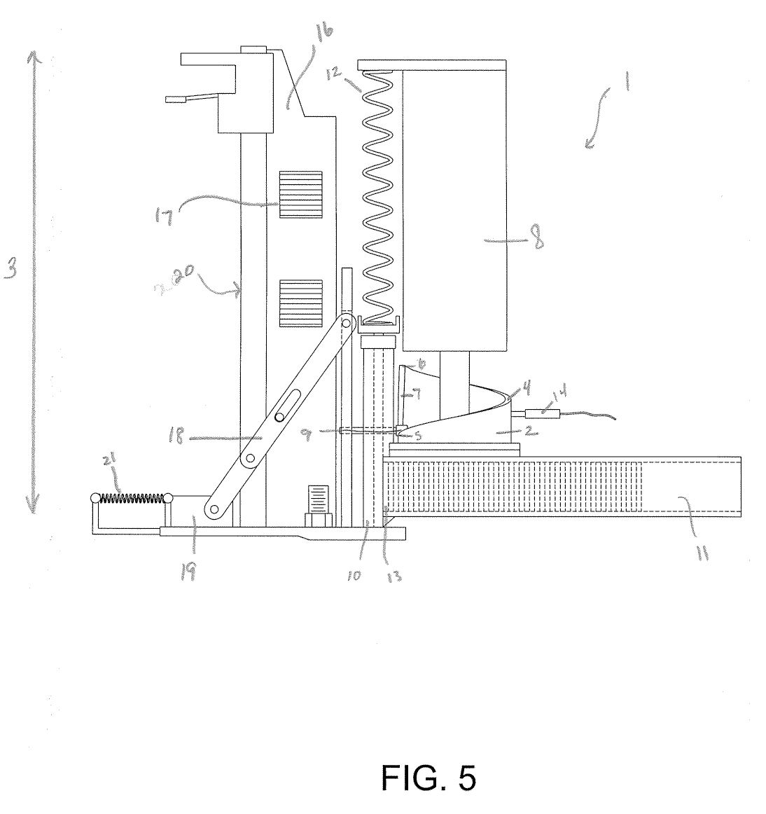

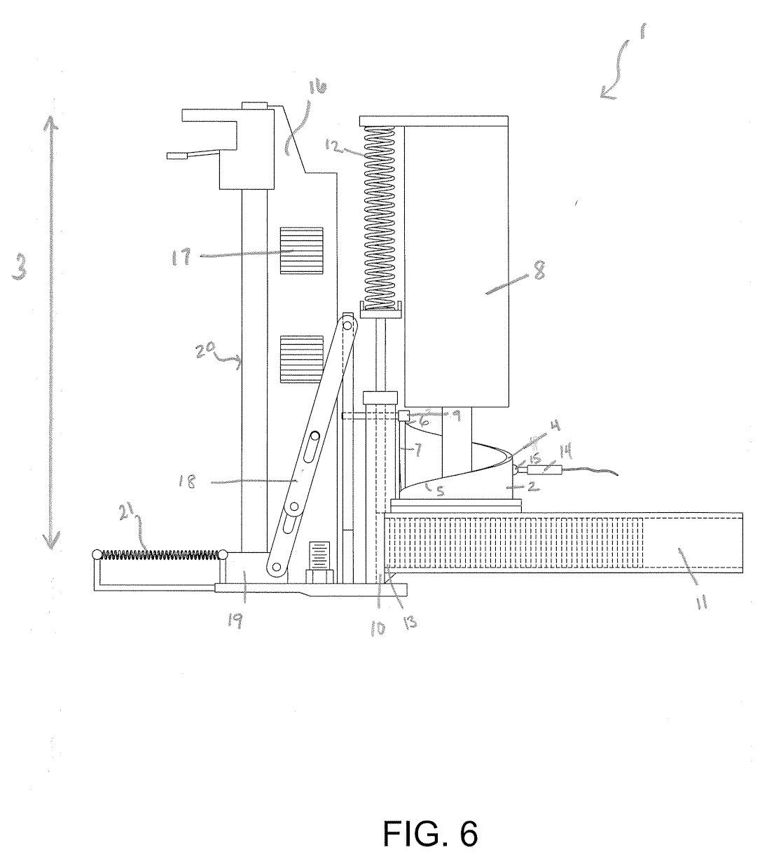

FIGS. 5 and 6 show the fastener applicator 1 of the present invention optionally including a cap applicator portion 20. In this embodiment, a cap tower 16 holds a plurality of stacked caps 17 which are partially shown in the holes depicted on the cap tower 16 in FIGS. 5 and 6. The plurality of stacked caps may stay down by gravity or may be forced down toward the workpiece through an internal spring, not shown. In this embodiment, when the fastener driver 10 is drawn away from the workpiece in direction 3, a sliding linkage 18 operably coupled to the fastener driver 10 pulls forward a cap positioner 19. The cap positioner 19 pushes the bottom-most cap, not shown, beneath the fastener which is about to be driven into the workpiece, not shown. When the bearing 9, moves toward the workpiece in direction 3, the sliding linkage 18, optionally combined with a spring 21 or other retractor mechanism, is forced back away from underneath the cap tower 16 such that the plurality of stacked caps 17 may be advanced down.

The sliding linkage 18 is useful for directing the motion of the cap positioner 19 because it can accommodate the difference in the distances that the bearing 9 and the cap positioner 19 travel during operation. The sliding linkage 18 is constructed of two linkage pieces each having holes on the ends and slots in the middle. One hole on one end of one of the pieces is connected to the fastener driver 10 or bearing 9 while one hole on one end of the other piece is connected to the cap positioner 19. The remaining hole of each piece is slidably connected to the slot of the other piece. By adjusting the length of the slots, the linkage can be made to pull the cap positioner 19 an appropriate distance to place a cap under a fastener when the fastener driver 10 is driven in direction 3.

The use of the sliding linkage 18 in this way is unique. The cap applicator portion 20 of the present invention may be combined with any fastener applicator having a fastener driver in the same way as the pieces are combined with the fastener applicator 1 of the present invention to provide for a new fastener and cap applicator which can drive a fastener through a cap into a workpiece.

Although the present invention has been described and illustrated with respect to a preferred embodiment and a preferred use therefor, it is not to be so limited since modifications and changes can be made therein which are within the fully intended scope of the invention.

I claim:

1. A fastener applicator for driving a fastener into a workpiece in a first direction, said fastener applicator comprising:
(a) a cam, said cam having an axis of rotation substantially parallel to said first direction, said cam having a ramped cam surface encircling said axis of rotation, said ramped cam surface having a first height with respect to said axis of rotation and a second height with respect to said axis of rotation, and said ramped cam surface further having heights intermediate said first and second heights angularly about said axis of rotation from said first to said second heights, said ramped cam surface further having an abrupt cliff portion transitioning from said second height to said first height;
(b) a motor for rotating said cam about said axis of rotation;
(c) a bearing in engagement with said ramped cam surface and mounted for reciprocation along said first direction as said cam rotates about said axis of rotation; and
(d) a fastener driver, operably coupled to said bearing for joint movement therewith, for driving said fastener into said workpiece.

2. The fastener applicator of claim 1 further comprising:
(e) a cap tower for holding a plurality of stacked caps;
(f) a cap positioner for positioning a cap beneath said fastener before said fastener driver drives said fastener into said workpiece; and
(g) a sliding linkage operably coupled to said cap positioner and said fastener driver operating to cause said cap positioner to position said cap beneath said fastener before said fastener driver drives said fastener into said workpiece.

3. The fastener applicator of claim 2 further comprising:
(h) a retractor operably coupled to said cap positioner and serving to retract said cap positioner as said fastener driver drives said fastener into said workpiece.

4. The fastener applicator of claim 3 wherein said retractor is a spring.

5. A fastener and cap applicator for driving a fastener through a cap into a workpiece comprising:
(a) a fastener applicator having a fastener driver for driving said fastener into said workpiece;
(b) a cap tower for holding a plurality of stacked caps;
(c) a cap positioner for positioning said cap beneath said fastener before said fastener driver drives said fastener into said workpiece;
(d) a sliding linkage operably coupled to said cap positioner and said fastener driver operating to cause said cap positioner to position said cap beneath said fastener before said fastener driver drives said fastener into said workpiece.

6. The fastener and cap applicator of claim 5 further comprising:
(e) a retractor operably coupled to said cap positioner and serving to retract said cap positioner as said fastener driver drives said fastener into said workpiece.
